(19) United States
(12) Patent Application Publication
(10) Pub. No.: US 2006/0175178 A1
(43) Pub. Date: Aug. 10, 2006

(54) Clamping device and device for transferring lolliops

(75) Inventor: Seferinus Jelle Asma, Veldhoven (NL)

Correspondence Address: YOUNG & THOMPSON, 745 SOUTH 23RD STREET, 2ND FLOOR, ARLINGTON, VA, 22202, US

(73) Assignee: CFS Weert B.V., Weert (NL)

(21) Appl. No.: 10/563,966

(22) PCT Filed: Jul. 8, 2004
(86) PCT No.: PCT/NL04/00494

§ 371 Date: Mar. 23, 2006

(30) Foreign Application Priority Data
Jul. 11, 2003 (NL) 1023908

(51) Int. Cl. B65G 47/84; A23G 3/02; A23G 7/00

(52) U.S. Cl. 198/377.07; 198/379

(57) ABSTRACT

Device for transferring lollipops provided with a stick, including a transferrer, a first conveyor for supply of the lollipops to the transferrer and a second conveyor for discharge of the lollipops from the transferrer, wherein the first conveyor and the second conveyor comprise series of lollipop holders provided with first and second lollipop clamps, respectively, disposed on a first and a second conveyor line, respectively, such as a chain, to keep the lollipops, in particular the sticks, in a first orientation and a second orientation, respectively, wherein the first and second orientations are at an angle to each other, and wherein the transferrer is provided with third lollipop clamps and a holder for them, wherein the holder is disposed for moving the third lollipop clamps from a position for taking over the lollipops supplied by the first conveyor in the first orientation to a position for discharge of the lollipops in the second orientation to the second conveyor. The first, second and/or third lollipop clamps can be designed for clamping the sticks of the lollipops.

The invention relates to a device for transferring lollipops from a supply conveyor to a discharge conveyor.

Lollipops are manufactured in a number of consecutive treatments. After forming the lollipop head around a stick, the lollipops can be passed through a cooling station, held by stick clamps that are attached to a driven conveyor line, such as a chain, of a conveyor, such as for instance an overhead conveyor. Subsequently the lollipops may be subjected to a further treatment, such as applying a coating, and/or be packaged, for instance in wraps, in a packaging station. The lollipops will then be conveyed by another conveyor that is also provided with stick clamps. By means of a transferrer the lollipops have to be transferred from the one conveyor to the next conveyor.

It is an object of the invention to provide a device of the type mentioned in the preamble, with which during transferring the orientation of the lollipops can also be easily and reliably changed.

From one aspect the invention provides a device for transferring lollipops provided with a stick, comprising a transferrer, a first conveyor for supply of the lollipops to the transferrer and a second conveyor for discharge of the lollipops from the transferrer, wherein the first conveyor and the second conveyor comprise series of lollipop holders provided with first and second lollipop clamps, respectively, disposed on a first and a second conveyor line, respectively, such as a chain, to keep the lollipops, in particular the sticks, in a first orientation and a second orientation, respectively, wherein the first and second orientations are at an angle to each other, and wherein the transferrer is provided with third lollipop clamps and a holder for them, wherein the holder is disposed for moving the third lollipop clamps from a position for taking over the lollipops supplied by the first conveyor in the first orientation to a position for discharge of the lollipops in the second orientation to the second conveyor.

The first, second and/or third lollipop clamps can be designed for clamping the sticks of the lollipops.

From a further aspect the invention to that end provides a device for transferring lollipops provided with a stick, comprising a transferrer, a first conveyor for supply of the lollipops to the transferrer and a second conveyor for discharge of the lollipops from the transferrer, wherein the first conveyor and the second conveyor comprise series of lollipop holders provided with first and second stick clamps, respectively, disposed on a first and a second conveyor line, respectively, such as a chain, to keep the sticks in a first orientation and a second orientation, respectively, wherein the first and second orientations are at an angle to each other, and wherein the transferrer is provided with third stick clamps and with a holder for them, wherein the holder is disposed for moving the third stick clamps from a position for taking over the sticks supplied by the first conveyor in the first orientation to a position for discharge of the sticks in the second orientation to the second conveyor.

With the device according to the invention the lollipops can reliably be transferred from the first conveyor to the second conveyor, while changing the orientation of the sticks.

Preferably the first and second orientation are approximately transverse to each other, preferably perpendicular to each other. Particularly in this way the orientation of the sticks can be changed to an orientation in a plane perpendicular thereto. Thus the sticks may for instance be transferred from a horizontal or vertical orientation in the first conveyor to a vertical or horizontal orientation in the second conveyor, wherein the lollipops will always have the correct orientation for that conveyor or the accompanying treatment, for instance for supply of lollipops or placement of lollipops in a packaging machine, such as a horizontal or a vertical form-fill-seal machine or a pouch-packaging machine.

It is also possible that either the first or the second stick clamps hold the lollipops in the vertical orientation with their heads hanging down, as a result of which for instance dipping the lollipop heads in a bath of liquid (such as chocolate) is possible, for coating the lollipop head.

Preferably the first conveyor is provided with first driving means for driving the first conveyor line for moving the first lollipop or stick clamps at a first speed, wherein the second conveyor is provided with second driving means for driving the second conveyor line for moving the second lollipop or stick clamps at a second speed, wherein the transferrer is provided with third driving means for driving the holder for moving the third lollipop or stick clamps at a third speed, wherein the third speed is higher than the first speed at the location where the lollipops are taken over by the transferrer.

Thus the removal of the lollipops or in particular sticks from the first lollipop or stick clamps is enhanced.

Preferably the second speed at the location where the lollipops or sticks are taken over from the transferrer is higher than the third speed, so that said removal is also enhanced.

In a further development of the device according to the invention, the holder is rotatable about a fixed centre line. In that case the holder takes up little space. The holder may in that case at rotation preferably describe a conical surface with the third clamps, preferably having an inclined centre line, preferably a centre line at 45 degrees, wherein the orientation of the third lollipop or stick clamps continuously alternates between a horizontal and a vertical position during the circulation.

Preferably the third lollipop or stick clamps comprise first and second metal, particularly steel clamps, which is advantageous because of the relatively high frequency with which the clamps have to be active in comparison with the (often synthetic) stick clamps of the much longer first and second conveyors. The third clamps are thus better resistant against the possible resulting wear.

Preferably the first clamp is L-shaped, and is hinged to the holder at the location of its corner, and of which the first leg at the end forms a first clamping surface, wherein third clamps comprise biassing means for biassing the first clamping surface to a second clamping surface provided on the second clamp, wherein the second leg of the first clamp is provided with a first cam follower surface for engagement of a stationary positioned cam, preferably comprising a roller, for rotation of the first clamp with respect to the second clamp. Thus the length of the third clamps can be kept limited and a compact set-up is possible. Moreover the length of the second leg may also be available for engagement and operation by the cam, as a result of which that engagement is less sudden and therefore involves less production of noise.

Preferably the first cam follower surface is curved, preferably concave, as a result of which a fluent motion of the second leg and thus rotation of the first clamp is possible and the noise production is further limited.

The fluent motion is further enhanced when the second leg of the first clamp is furthermore provided with a convex top fluently following the first cam follower surface, with which top the ultimate open position of the first clamp is defined.

The fluent motion is completed when a second cam follower surface, which preferably is curved, particularly concave, follows the convex top. The closing motion can then take place with a limited production of noise.

Preferably the chords of the arcs of the first and second cam follower surfaces enclose an obtuse angle.

In a simple construction the second clamp is stationary with respect to the first clamp.

It is a further object of the invention to provide a clamping device for sticks of lollipops which is wear-resistant and takes up little space. It is a further object of the invention to provide such a clamping device that is able to operate noiselessly.

From a further aspect the invention provides a clamping device for holding products provided with sticks, such as lollipops, comprising first and second metal, particularly steel clamps, wherein the first clamp is L-shaped, and is hinged to a mobile holder at the location of its corner, and of which the first leg at the end forms a first clamping surface, wherein the holder comprises biassing means for biassing the first clamping surface to a second clamping surface provided on the second clamp, wherein the second leg of the first clamp is provided with a first cam follower surface for engagement of a with respect to the holder stationary positioned cam, preferably comprising a roller, for rotation of the first clamp with respect to the second clamp.

Such a clamping device cannot only be used in the holder of the aforementioned transfer device, but also in other structures where the available space is limited and/or the clamps have to function relatively intensively.

For preferred embodiments the above-mentioned preferred embodiments of the third clamps are referred to in short.

A further object of the invention is to provide a device for conveying lollipops, with which the lollipops during continuing line conveyance are able to be subjected to a treatment.

From a further aspect the invention to that end provides a device for conveying lollipops provided with sticks, comprising a conveyor having a driven conveyor line, such as a chain, on which a series of stick holders are disposed in line one after the other, wherein the stick holders are oriented for holding the lollipops substantially vertical with their heads hanging down during continuous conveyance. With this device the lollipop heads may during continuous conveyance to a next machine for instance be passed through a bath in order to provide the head with a coating, for instance of chocolate.

The invention will be elucidated on the basis of an exemplary embodiment shown in the attached drawings, in which:

FIG. 1 shows a schematic front view of an installation which includes an example of a transfer device according to the invention;

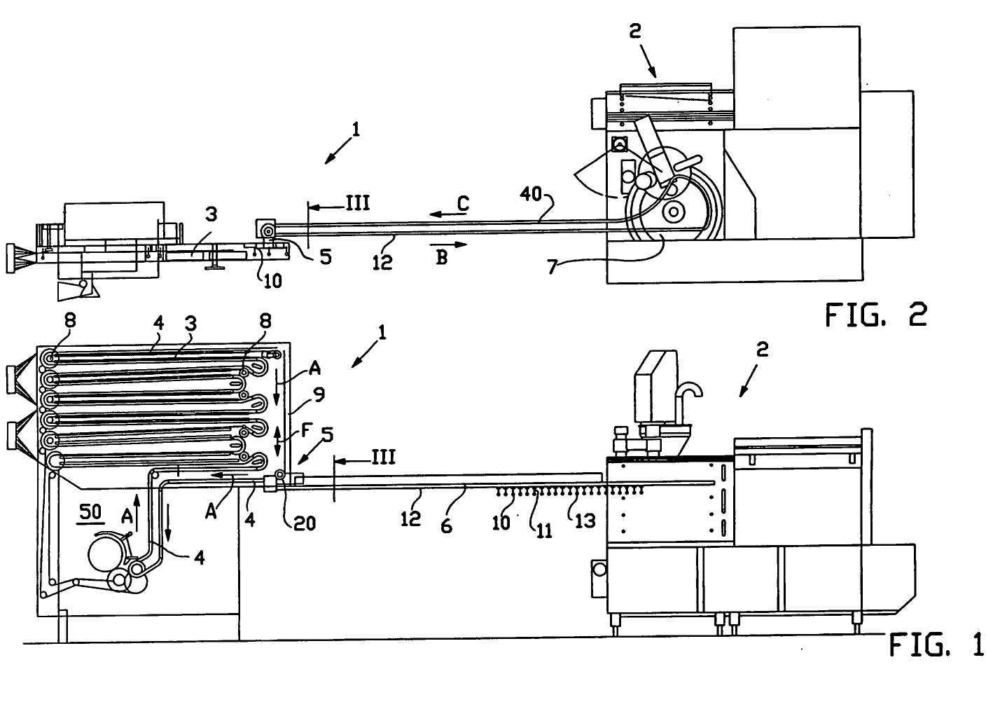

FIG. 2 shows a top view of the installation of FIG. 1;

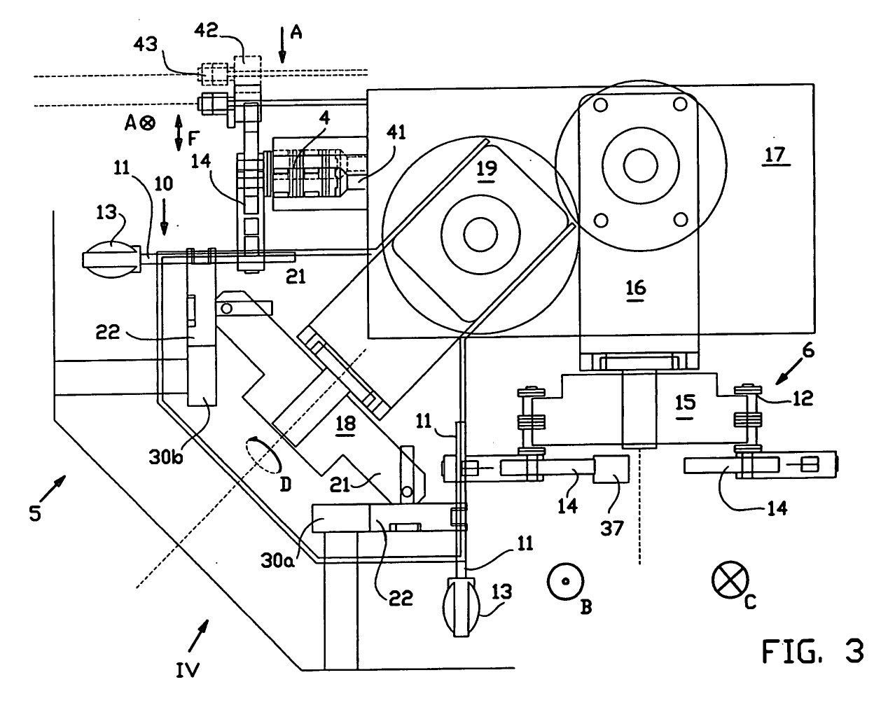

FIG. 3 shows a schematic view of the transfer device in the installation of the FIGS. 1 and 2;

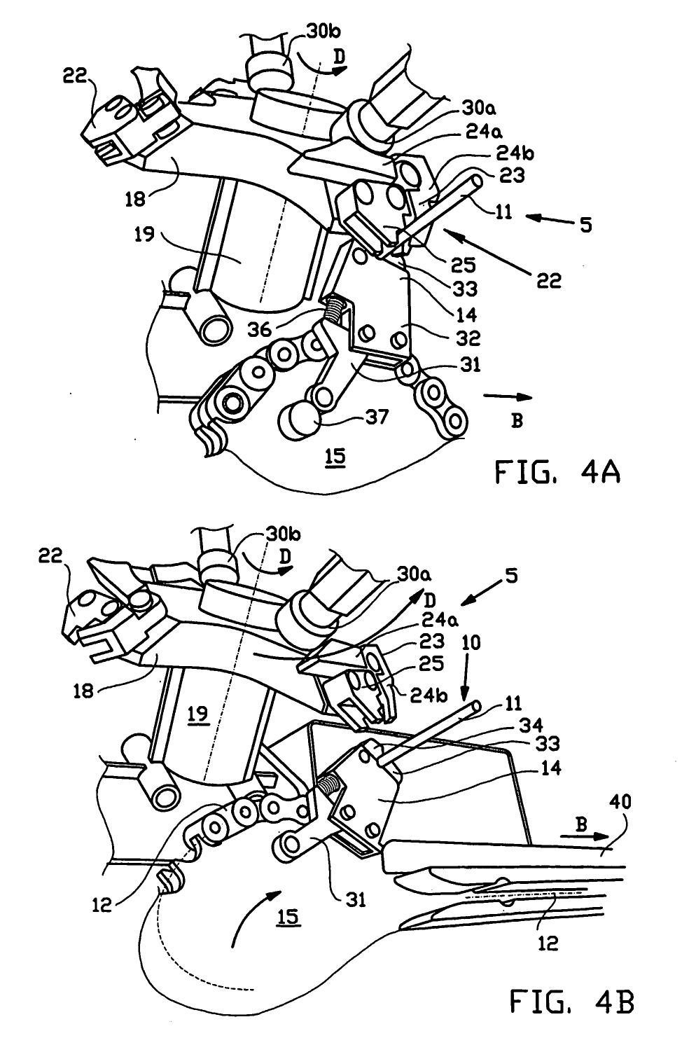

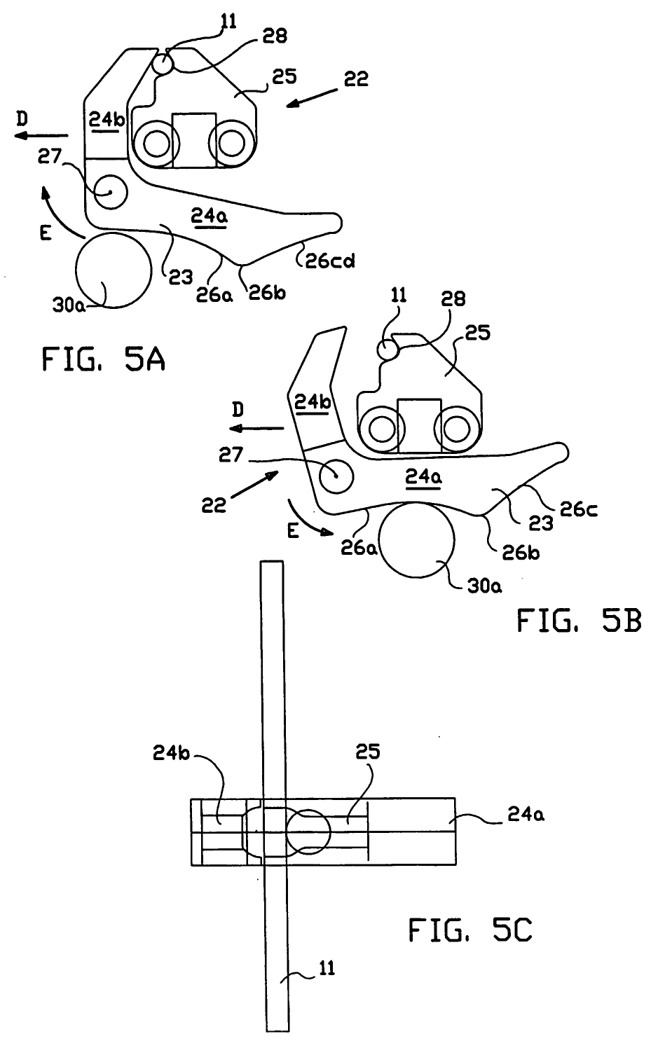

FIGS. 4A and 4B show two consecutive stages in the transferring with the transfer device of FIG. 3; and

FIGS. 5A-C show two consecutive stages in a clamp of the transfer device of FIG. 3 and a top view thereon, respectively.

In FIGS. 1 and 2 a device 1 for producing lollipops is shown, which includes a press mould part 50, in which the lollipops are formed, and a cooling chamber 3 placed on top of it. On the right-hand side a packaging machine 2 is positioned for packaging the lollipops 10 produced with the device 1. The lollipops 10 are provided with a stick 11 and head 13.

In the press moulding chamber 50 and the cooling chamber 3 a chain 4 circulates in the direction A in a zig-zag manner between rollers 8, the chain having a downward track 9 above the transferrer 5 that is detachably attached in the device 1.

Between the transferrer 5 and the packaging device 2 a conveyor 6 extends, having a chain 12 provided with clamps 14 (see FIG. 3) circulating in direction B and C. The chain 12 is guided in guides 40, that can be coupled to the production device 1 and to the packaging device 2. At the location of the packaging device 2 the chain 12 circulates in the manner as shown in FIG. 2, above a sorting disc 7.

It is observed that the packaging device 2 may also be designed differently, for instance provided with an operation mechanism for the clamp 14, to release the lollipops 10 one by one above an entrance for the packaging device, for instance for packaging the lollipops in singled condition in one bag each.

The packaging device 2 may also be replaced by a device for further treatment of the lollipops 10, for instance for applying a coating by means of a bath.

The transferrer 5 is further shown in FIG. 3, as well in FIGS. 4A and 4B. The transferrer 5 comprises a holder body 17 attached to the device 1. By means of a gearbox 16 attached to holder 17, a chain pulley 15 is driven for rotation, and thus for driving the chain 12 in the directions B, C. The gearbox 16 is driven in a way not further shown by sprocket wheel 20 yet to be discussed. Stick clamps 14 are attached to chain 12 at regular intervals, and are brought into circulation with it. The chain circulates in a horizontal plane.

As can be seen in FIG. 1 the chain 4 circulates about sprocket wheel 20, while changing the vertical motion into a horizontal motion. In FIG. 3 it can be seen that on chain 4 stick clamps 14 have been attached that correspond with the stick clamps 14 of the conveyor 6. An operation roller 42 is disposed above the course of the chain 4 at that location, along which the operation arm yet to be discussed of the stick clamps 14 may run to be operated for opening the stick clamps 14. The chain 4 is guided by synthetic guide 41.

With the driven chain 4 the sprocket wheel 20 is driven. The chain 4 is kept biassed with means that are not further discussed.

The sprocket wheel 20 is hydraulically and controllably adjustable as to height (arrows F) in order to rise or lower the course of the chain 4 (see dotted and drawn chain 4 in FIG. 3). The operation roller 42 as well is adjustable as to height in the direction F, optionally by means of securing pin 43. By placing the sprocket wheel 20 and the roller 42 high the lower end of the downward track 9 will come to lie high, and thus out of reach of the transfer parts of the transferrer 5. The drive coupling between the sprocket wheel 20 and the gearboxes 16 and 19 (see below) can then be interrupted as well. During the adjustment the chain 4 remains biassed.

Between the chain 3 circulating the vertical plane and the chain 12 circulating in the horizontal plane, a transfer wheel 18 has been placed as a permanent part of the transferrer 5, which transfer wheel is driven by sprocket wheel 20 in manner not further shown, via gearbox 19, and is thus rotated in the direction D about an axis of rotation of, in this example 45° to the vertical and horizontal. The transfer wheel 18 is mechanically coupled to the chain pulley 15 via gearboxes 19 and 16.

In this case the transfer wheel 18 is provided with four arms 21, on which stick clamps 22 are disposed, at 45° to the axis of rotation. As can be seen in FIG. 3 the stick clamps 22 as a result move from a vertical position to a horizontal position.

The stick clamps 22, shown in FIGS. 5A-C comprise a permanent clamping part 25 and a movable clamp lever 23, that hinges about pin 27, that is attached to an arm 21 in question (FIG. 3). The clamp lever 23 comprises an operation arm 24a and a clamp arm 24b. In the situation shown in figure 5A, the clamp arm 24b clamps a lollipop stick 11, while cooperating with a recess 28 in fixed clamp part 25. The parts 23 and 25 may be made of metal.

The operation arm 24a has an operation surface that cooperates with operation rollers 30a, 30b that are fixedly attached to holder 17 (see FIG. 3). To that end the operation arm 24a has a concave run-in surface 26a, a convex transition 26b and a concave run-out surface 26c. The lever 23 is spring-biassed to the closed position.

Due to movement in the direction D of the stick clamp 22 with respect to the operation roller 30a (or 30b), the operation roller 30a fluently and evenly contacts the operation arm 24a in an increasingly pressing manner, as a result of which it tilts about pins 27 in the direction E, from the position shown in FIG. 5A to the position shown in FIG. 5B in which the clamping action has ended. The open position will be maximal when the transition 26b is situated above the roller 30a. After that the operation arm 24a will, in a controlled manner, rotate back to the orientation shown in FIG. 5A, due to the contact with the concave run-out surface 26c, without there being question of a slapping noise or the like. It will be understood that the opening and closing motion in question will also take place at roller 30b, where the sticks are received in the clamps 22.

The transfer process of the clamps 14 to the clamps 22 in principle is the same as the transfer process of the clamps 22 to the clamps 14 of the chain 12. When transferring the clamps 14 of chain 3 to the clamps 22 of transfer wheel 18 it is ensured that the speed of movement at the location of the actual clamping location for the clamps 22 is larger than the speed of movement of the clamps 14. Considered in FIG. 3, the motion is perpendicular to the paper, away from the perceiver, wherein the clamping jaw 33, particularly the lever arm 31 (see FIG. 4A) forming a unity therewith, is rotated due to abutment against roller 42 so that it swings in holder 32 of clamp 14, is rotated to an open position, at a distance from the permanent clamping jaw 34. At that moment with a rotational motion (the circulation of wheel 18) the clamp opening of the clamp 22 has also arrived at that location, in order to abut the stick 11 in the same (horizontal) plane, wherein stick 11 comes to lie in recess 28. The clamp lever 23 is then already placed in the open position, by cooperation of the operation arm 24a with the operation roller 30b. At this moment, the clamps 14 and 22 extend in substantially parallel (vertical) planes. The clamp lever 23 is closed and the stick 11 is taken out of the open space between clamps 33 and 34.

The wheel 18 is rotated 90°, wherein the clamps 22 are rotated to a horizontal position, in a plane parallel to but situated slightly below the circumferential plane for the clamps 14 of chain 12. Due to the chosen layout of the gearbox 16 driven via wheel 20 and the diameter of the sprocket wheel 15 it is ensured that the speed of movement of the clamp opening of the clamps 14 at the point of taking over is larger than the speed in question of the clamps 22. Due to cooperation between the clamp lever 31 and the operation roller 37 the clamp 14 is opened for receiving the stick 11 held by clamp 22. In FIG. 4A the moment is shown in which the clamp lever 31 is free again and the clamps 33 and 34 are closed. It can be seen that the operation arm 24a with surface 26a is in the process of running up on operation roller 30a, so that the clamp lever 23 is rotated and the clamp arm 24b is swung away from clamp part 25 in order to open the clamp 22. Thus, as shown in FIG. 4B, the clamp 14 is able to take the stick 11 out of the clamp 22 and convey it further in the direction B, to the location of further treatment, such as the packaging machine 2.

1.-26. (canceled)

27. Device for transferring lollipops provided with a stick, comprising a transferrer, a first conveyor for supply of the lollipops to the transferrer and a second conveyor for discharge of the lollipops from the transferrer, wherein the first conveyor and the second conveyor comprise series of lollipop holders provided with first and second lollipop clamps, respectively, disposed on a first and a second conveyor line, respectively, such as a chain, to keep the lollipops, in particular the sticks, in a first orientation and a second orientation, respectively, wherein the first and second orientations are at an angle to each other, and wherein the transferrer is provided with third lollipop clamps and a holder for them, wherein the holder is disposed for moving the third lollipop clamps from a position for taking over the lollipops supplied by the first conveyor in the first orientation to a position for discharge of the lollipops in the second orientation to the second conveyor.

28. Device according to claim 27, wherein the first, second and/or third lollipop clamps are designed for clamping the sticks of the lollipops.

29. Device according to claim 27, wherein the first and second orientation are approximately transverse to each other.

30. Device according to claim 29, wherein the first and second orientation are perpendicular to each other.

31. Device according to claim 27, wherein the first orientation or second orientation is vertical.

32. Device according to claim 31, wherein the first or second lollipop stick clamps hold the lollipops in the vertical orientation with their heads hanging down.

33. Device according to claim 27, wherein the first conveyor is provided with first driving means for driving the first conveyor line for moving the first lollipop clamps at a first speed, wherein the second conveyor is provided with second driving means for driving the second conveyor line for moving the second lollipop clamps at a second speed, wherein the transferrer is provided with third driving means for driving the holder for moving the third lollipop clamps at a third speed, wherein the third speed is higher than the first speed at the location where the lollipops are taken over by the transferrer.

34. Device according to claim 33, wherein the second speed at the location where the lollipops are taken over from the transferrer is higher than the third speed.

35. Device according to claim 27, wherein the holder is rotatable about a fixed centre line.

36. Device according to claim 35, wherein at rotation the holder describes a conical surface with the third lollipop clamps.

37. Device according to claim 36, wherein the orientation of the third lollipop clamps continuously alternates between a horizontal and a vertical position during the circulation.

38. Device according to claim 36, wherein the conical surface has an inclined centre line, preferably a centre line at 45 degrees,

39. Device according to claim 27, wherein the third lollipop clamps comprise first and second metal, particularly steel clamps.

40. Device according to claim 39, wherein the first clamp is L-shaped, and is hinged to the holder at the location of its corner, and of which the first leg at the end forms a first clamping surface, wherein third clamps comprise biassing means for biassing the first clamping surface to a second clamping surface provided on the second clamp, wherein the second leg of the first clamp is provided with a first cam follower surface for engagement of a stationary positioned cam, preferably comprising a roller, for rotation of the first clamp with respect to the second clamp.

41. Device according to claim 40, wherein the first cam follower surface is curved, preferably concave.

42. Device according to claim 40, wherein the second leg of the first clamp is furthermore provided with a convex top fluently following the first cam follower surface, with which top the ultimate open position of the first clamp is defined.

43. Device according to claim 42, wherein a second cam follower surface, which preferably is curved, particularly concave, follows the convex top.

44. Device according to claim 43, wherein the chords of the arcs of the first and second cam follower surfaces enclose an obtuse angle.

45. Device according to claim 40, wherein the second clamp is stationary with respect to the first clamp.

46. Clamping device for holding products provided with sticks, such as lollipops, comprising first and second metal, particularly steel clamps, wherein the first clamp is L-shaped, and is hinged to a mobile holder at the location of its corner, and of which the first leg at the end forms a first clamping surface, wherein the holder comprises biassing means for biassing the first clamping surface to a second clamping surface provided on the second clamp, wherein the second leg of the first clamp is provided with a first cam follower surface for engagement of a with respect to the holder stationary positioned cam for rotation of the first clamp with respect to the second clamp.

47. Device according to claim 46, wherein the first cam follower surface is curved, preferably concave.

48. Device according to claim 46, wherein the second leg of the first clamp is provided with a convex top fluently following the first cam follower surface, with which top the ultimate open position of the first clamp is defined.

49. Device according to claim 48, wherein a second cam follower surface, which preferably is curved, particularly concave, follows the convex top.

50. Device according to claim 49, wherein the chords of the arcs of the first and second cam follower surfaces enclose an obtuse angle.

51. Device according to claim 46, wherein the second clamp with respect to the first clamp is stationary attached to the holder.

52. Device according to claim 46, adapted for clamping a stick of a lollipop.

53. Device according to claim 46, wherein the cam comprises a roller.

54. Device for transferring lollipops provided with a stick, comprising a transferrer, a first conveyor for supply of the lollipops to the transferrer and a second conveyor for discharge of the lollipops from the transferrer, wherein the first conveyor and the second conveyor comprise series of lollipop holders provided with first and second stick clamps, respectively, disposed on a first and a second conveyor line, respectively, such as a chain, to keep the sticks in a first orientation and a second orientation, respectively, wherein the first and second orientations are at an angle to each other, and wherein the transferrer is provided with third stick clamps and a holder for them, wherein the holder is disposed for moving the third stick clamps from a position for taking over the sticks supplied by the first conveyor in the first orientation to a position for discharge of the sticks in the second orientation to the second conveyor.
